(19) United States
(12) Patent Application Publication
(10) Pub. No.: US 2012/0005721 A1
(43) Pub. Date: Jan. 5, 2012

(54) PROCESSING UNIT ENCLOSED OPERATING SYSTEM

(76) Inventors: Zhangwei Xu, Redmond, WA (US); Thomas G. Phillips, Bellevue, WA (US); Alexander Frank, Bellevue, WA (US); Curt A. Steeb, Redmond, WA (US); Isaac P. Ahdout, Bellevue, WA (US); Martin H. Hall, Sammamish, WA (US); James S. Duffus, Seattle, WA (US)

(21) Appl. No.: 13/171,993

(22) Filed: Jun. 29, 2011

Related U.S. Application Data
(63) Continuation of application No. 11/224,418, filed on Sep. 12, 2005, now abandoned.

(51) Int. Cl. G06F 21/00

(52) U.S. Cl. 726/1

(57) ABSTRACT

A processing unit for use in an electronic device includes standard instruction processing and communication interfaces and also includes functional capability in addition to or in place of those found in an operating system. A secure memory within the processing unit may contain a hardware identifier, policy data, and subsystem functions such as a secure clock, policy management, and policy enforcement. Data in functions within the secure memory are not accessible from outside the processing unit.

### CROSS-REFERENCE TO RELATED APPLICATION(S)

The present application is a continuation of U.S. patent application Ser. No. 11/224,418, filed Sep. 12, 2005, the contents of each of which are hereby incorporated by reference in their entireties.

### BACKGROUND

Computers that operate using an architecture with a hardware processing platform hosting a software operating platform, or operating system are in use. The operating system is designed to be independent of the processing platform (at least within broad parameters) and conversely, the processing platform is designed independently (within the generally same broad parameters) from the operating system. For example, either Linux or Microsoft Windows may be run on most versions of Intel x86 processor. By using a virtual machine monitor (VMM) or hypervisor, it is possible to run both operating systems concurrently. Similarly, some operating systems, such as UNIX, may run on more than one kind of processor, for example, IBM PowerPC and Sun Sparc processors.

This independence between processing platform and operating system introduces security risks that can be exploited by would-be hackers, in part because of the difficulty in establishing trust between the processor and operating system, that is, between the hardware and the software of the computer. Current microprocessors enter a “fetch and execute” cycle that blindly executes the instructions given to it and are not concerned with the contents or ramifications of the executed instructions nor do they participate in policy decisions related to use of the electronic device.

A processing unit with embedded system functions provides a secure base for enforcing security and/or operating policies, for example, for use in enforcing pay-per-use, pay-as-you-go, or other metered operation of an electronic device such as a computer, cellular telephone, personal digital assistant, media player, etc. The processing unit may include features and functional support found in most or all modern microprocessors and also support additional functions providing a hardware identifier, a tamper-resistant clock, and secure storage. Other functional capabilities such as a cryptographic unit, may be present as well. The result is a processing unit that is not reliant on any outside components, particularly operating system software, a trusted computing module (TCM), or secure-boot BIOS to establish the basis for computer capable of being operated in compliance to a usage policy.

### SUMMARY

When booted, the processing unit determines what policy is active and sets the system configuration in accordance with the policy, for example, setting limits on available memory, number or type of peripherals, or network communications. The clock provides a trustworthy time for use in metering usage, such as use over a period of time, and as a reference to detect tampering with the system clock.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a block diagram of a computer showing details of the processing unit; and

FIG. 4 is a block diagram of a computer showing details of an alternate embodiment of the processing unit of FIG. 3.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term “_” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

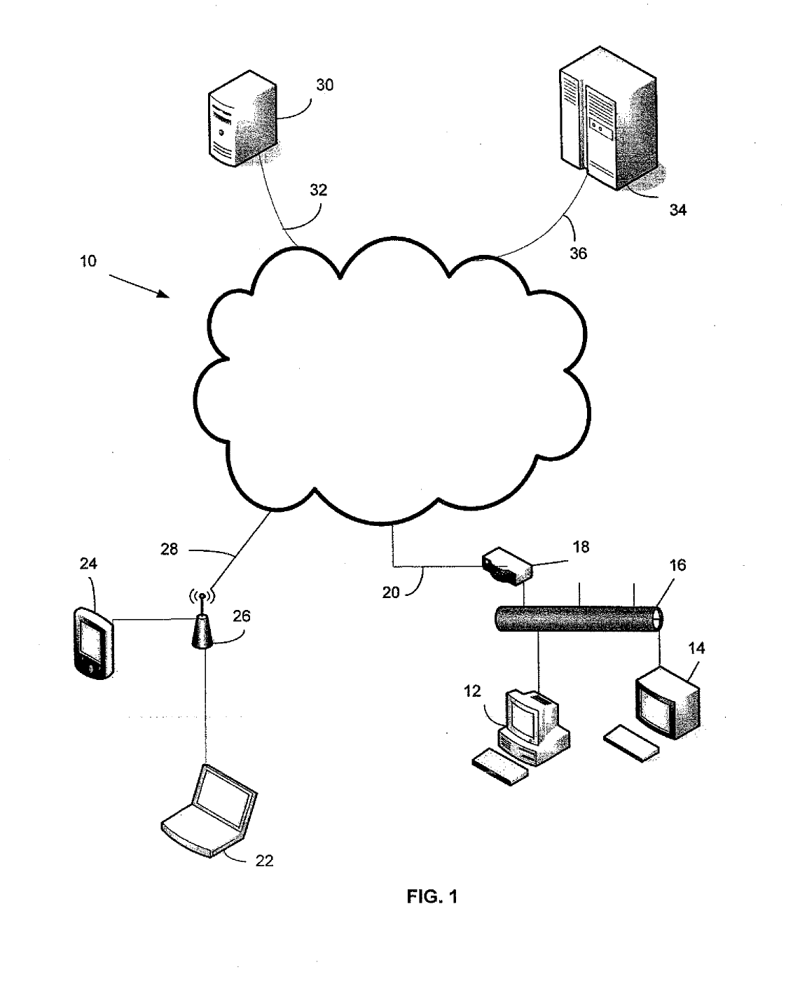

FIG. 1 illustrates a network 10 that may be used to implement a pay-per-use computer system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36.

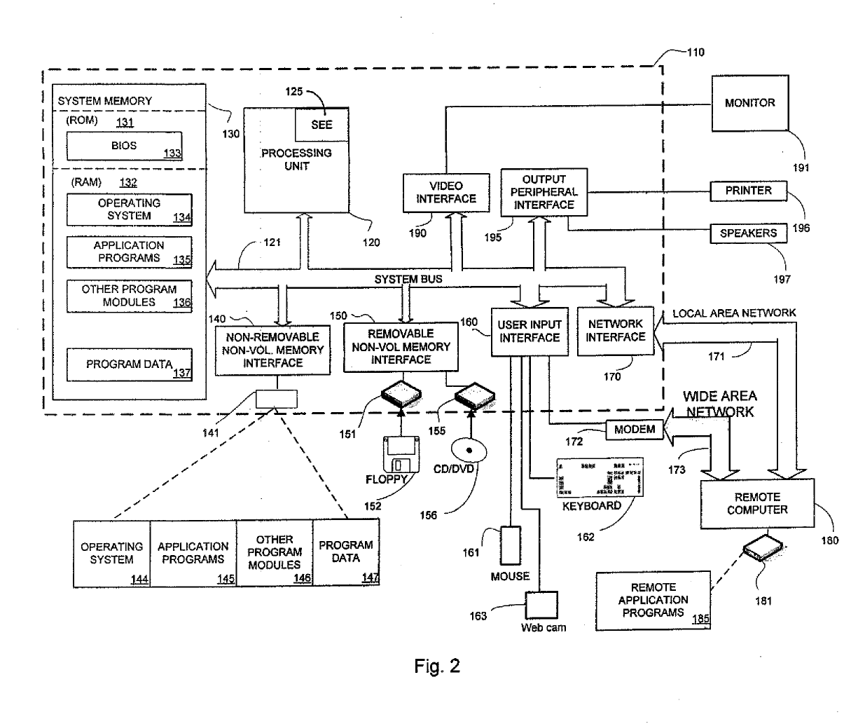

FIG. 2 illustrates a computing device in the form of a computer 110 that may be connected to the network 10 and used to implement one or more components of the dynamic software provisioning system. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

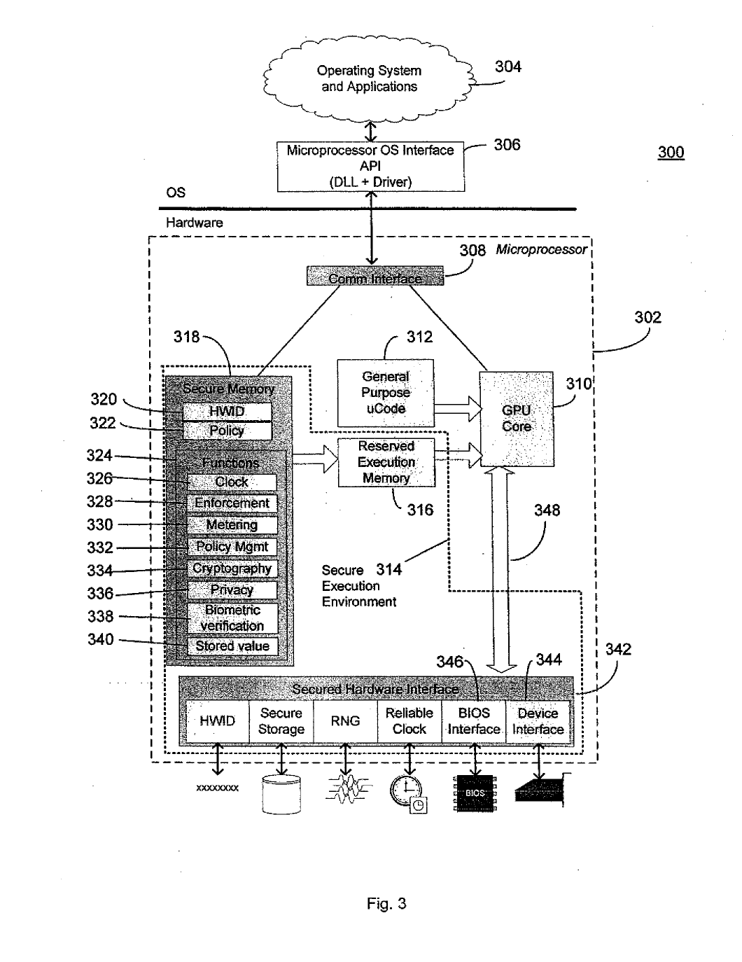

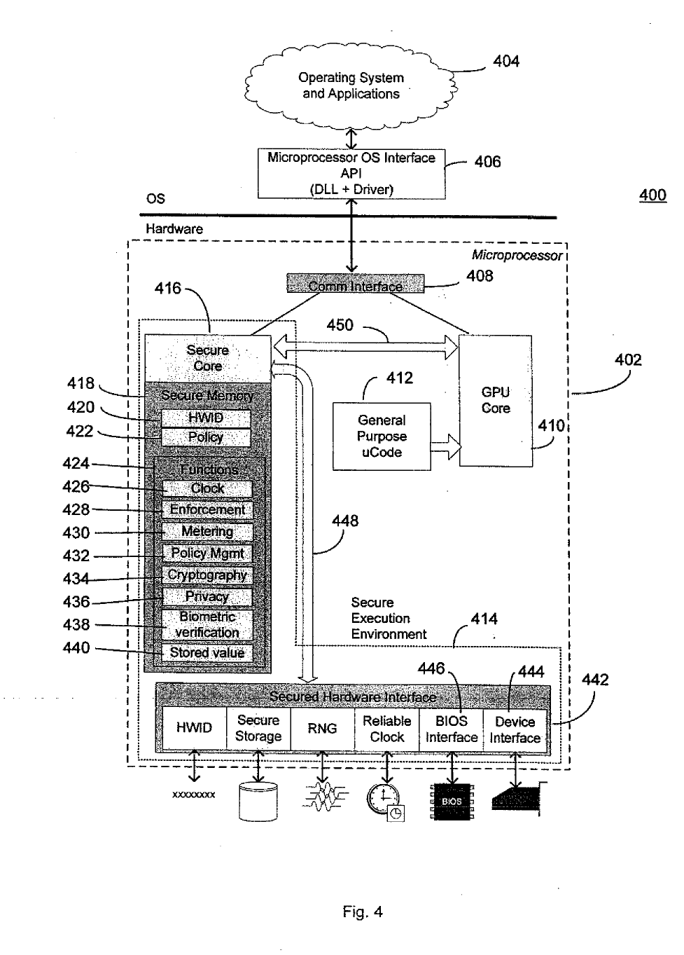

The processing unit 120 may be a microprocessor such as a microprocessor available from Intel, or others, as is known in the art. The processing unit may be a single chip or may be a multiple processor unit and may include associated peripheral chips (not depicted) or functional blocks (not depicted). Such associated chips may include pre-processors, pipeline chips, simple buffers and drivers, or may include more complex chips/chip sets such as the “Northbridge” and “Southbridge” chips known in some current technology computer architectures. The processing unit 120 may also include a secure execution environment 125, either on the same silicon as the microprocessor or as a related chip as part of the overall processing unit. The secure execution environment 125 and its interaction with the processing unit 120, or equivalent devices, is discussed in more detail below with respect to FIG. 3 and FIG. 4.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Another input device may be a camera for sending images over the Internet, known as a web cam 163. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

FIG. 3 depicts a simplified block diagram of a computer 300. The computer includes a processing unit 302, that may be similar to or the same as the processing unit 120. The block diagram also depicts the computer 300 having an operating system and applications 304 that are coupled to the processing unit 302 by an interface application program interface (API) 306. The API 306 may communicate with a communication interface 308 in the processing unit 302. The communication interface 308 may take the form of an interrupt handler or, message processing handler, parsing unit, etc. As found in conventional microprocessors, the processing unit 302 may include a general processing unit (GPU) core 310 that processes general-purpose instructions received through the communication interface 308 using a general-purpose set of microcode 312. The operation of the GPU core 310 and its relationship to the general-purpose microcode 312 is well-documented and understood in the industry, and is exemplified in processors such as the Intel Pentium™ series, ARM™ processors from Advanced Risc Machines Limited, and IBM's PowerPC™ processor.

A secure execution environment 314 may supplement the general processing capabilities provided by the GPU core and microcode 310 312. The secure execution environment 314 may include a reserved execution memory 316. The reserved execution memory 316 may provide a highly secure location for the execution of instructions having an elevated privilege level within the processing unit 302. This elevated privilege level of operation may allow the processing unit 302 to execute code that is not directly accessible from outside the processing unit 302. For example, a particular interrupt vector may set the processing unit 302 into secure operation, or instructions may be evaluated for content requiring secure resources. When operating in this elevated privelege mode, the processing unit 302 acts as a full subsystem and does not require any external assets, for example BIOS resources, program memory, or a TCM, to build a secure processing environment.

A secure memory 318 may store, in a tamper-resistant manner, code and data related to the secure operation of the computer 302. The communication interface 308 may determine which instructions entering the processor 302 should be directed to the secure memory 318, and subsequently for execution in the reserved execution memory 316. Data in the secure memory 318 may include an identification indicia or hardware identifier 320 and policy data 322 that may specify policy related operational directives such as metering, reporting, update requirements, etc. The secure memory 318 may also include code or data required to implement various functions 324. The functions 324 may include a clock 326 or timer implementing clock functions, enforcement functions 328, metering 330, policy management 332, cryptography 334, privacy 336, biometric verification 338, and stored value 340 to name a few.

The clock 326 may provide a reliable basis for time measurement and may be used as a check against a system clock maintained by the operating system 134 to help prevent attempts to fraudulently use the computer 300 by altering the system clock. The clock 326 may also be used in conjunction with policy management 332, for example, to require communication with a host server to verify upgrade availability. The enforcement functions 328 may be loaded into the reserved execution memory 316 and executed when it is determined that the computer 300 is not in compliance with one or more elements of the policy 322. Such actions may include restricting system memory 132 by directing the processing unit 302 to allocate generally available system memory for use by the secure execution environment 314. By reallocating system memory 134 to the secure execution environment 314, the system memory 134 is essentially made unavailable for user purposes.

Another function 324 may be metering 330. Metering 330 may include a variety of techniques and measurements, for example, those as discussed in co-pending U.S. patent application Ser. No. 11/006,837. Whether to meter and what specific items to measure may be a function of the policy 322 is implemented by the policy management function 332. A cryptography function 334 may be used for digital signature verification, digital signing, random number generation, and encryption/decryption. Any or all of these capabilities may be used to verify updates to the secure memory 318 or to established trust with an entity outside the processing unit 302 whether inside or outside of the computer 300.

The secure execution environment 314 may allow several special-purpose functions to be developed and used. A privacy manager 336 may be used to manage personal information for a user or interested party. For example, the privacy manager 336 may be used to implement a “wallet” function for holding address and credit card data for use in online purchasing. A biometric verification function 338 may be used with an external biometric sensor to verify personal identity. Such identity verification may be used, for example, to update personal information in the privacy manager 336 or when applying a digital signature. As mentioned above, the cryptography function 334 may be used to establish trust and a secure channel to an external biometric sensor (not depicted).

A stored value function 340 may also be implemented for use in paying for time on a pay-per-use computer or while making an external purchases, for example, online stock trading transactions.

The use of data and functions from the secure memory 318 for execution in the reserved execution memory 316 allows presentation of a secured hardware interface 342. The secured hardware interface 342 allows restricted and or monitored access to peripheral devices 344 or the BIOS 346. Additionally the functions 324 may be used to allow external programs, including the operating system 134, to access secure facilities such as hardware ID and random number generation via logical connection 348 between the GPU 310 in the secured hardware interface 342. In addition, each function discussed above, as implemented in code and stored in the secure memory 318 may be implemented in logic and instantiated as a physical circuit. The operations to map functional behavior between hardware and software are well known in the art and are not discussed here in more detail.

In operation, a designated interrupt may be processed by the communication interface 308 causing data or one or more functions to be loaded from the secure memory 318 to the reserved execution memory 316. The GPU 310 may execute from the reserved execution memory 316 to implement the function. In one embodiment, the functions 324 available may supplement or replace standard functions available in the operating system 134. When configured in this manner, a corresponding operating system 134 will only operate when paired with processing unit 302. Carrying this concept to another level, another embodiment of the processing unit 302 may be programmed to trap external operating system functions unless executed from the reserved execution memory 316. For example, attempts to allocate memory by the external operating system 134 may be denied or redirected to internally stored functions. When configured in this manner, only an operating system specifically configured for processing unit 302 will operate correctly. In yet another embodiment, policy data 322 and policy management functions 332 may test operating system 134, application program 135, and hardware parameters to ensure that authorized software and hardware is present.

In one embodiment, the computer 300 boots using a normal BIOS startup procedure. At a point when the operating system 134 is being activated, the processing unit 302 may load the policy management function 332 into reserved execution memory 316 for execution to configure the computer 300 according to the policy data 322. The configuration process may include allocation of memory, processing capacity, peripheral availability and usage as well as metering requirements. When metering is to be enforced, policies relating to metering, such as what measurements to take, for example, by CPU usage or over a period of time, may be activated. Additionally, when usage is charged per period or by activity, a stored value balance may be maintained using the stored value function 340. When the computer 300 has been configured according to the policy 322, the normal boot process may continue by activating and instantiating the operating system 134 and other application programs 135. In other embodiments the policy may be applied to different points in the boot process or normal operation cycle.

Should non-compliance to the policy be discovered, the enforcement function 328 may be activated. A discussion of enforcement policy and actions may be found in co-pending application U.S. patent application Ser. No. 11/152,214. The enforcement function 328 may place the computer 300 into an alternate mode of operation when all attempts to restore the computer to compliance with the policy 322 fail. For example, in one embodiment, a sanction may be imposed by reallocating memory from use as system memory 130 and designating it as secure memory 318. Since secure memory 318 is not addressable by outside programs including the operating system 134, the computer's operation may be restricted, even severely, by such memory allocation.

Because the policy and enforcement functions are maintained within the processing unit 302, some typical attacks on the system are difficult or impossible. For example, the policy may not be “spoofed” by replacing a policy memory section of external memory. Similarly, the policy and enforcement functions may not be “starved” by blocking execution cycles and their respective address ranges.

To revert the computer 300 to normal operation, a restoration code may need to be acquired from a licensing authority or service provider (not depicted) and entered into the computer 300. The restoration code may include the hardware ID 320, a stored value replenishment, and a “no-earlier-than” time used to verify the clock 326. The restoration code may typically be encrypted and signed for confirmation by the processing unit 302.

Additional updates to the data in the secure memory 318 may be allowed only when specific criteria are met, for example, when the updates are verified by digital signature.

FIG. 4 is a block diagram of a computer 400 showing an alternate embodiment of the processing unit 302 shown in FIG. 3. The computer 400 has a processing unit 402, an operating system 404 and a microprocessor operating system interface application program interface (API) 406. The processing unit 402 includes a communication interface 408 that may operate in a fashion similar to the communication interface 308 by directing data traffic to an appropriate microprocessor function based on a criteria such as interrupt characteristics or address range. The processing unit 402 may have a conventional general processing unit (GPU) 410 and corresponding general purpose microcode 412. A secure execution environment 414 may include the same or similar functions found in the secure execution environment 314 with the addition of a separate secure core processor 416. The secure core processor 416 may allow an additional level of independence from the GPU core 410 and a corresponding increase in security of the processing unit 402.

The secure memory 418 may include a hardware ID 420 and policy data 422 in addition to general purpose functions 424 that operate as discussed above with respect to FIG. 3, for example clock 426, enforcement 428, metering 430, policy management 432, and cryptography 434. Additionally, special-purpose functions such as privacy management 436, biometric verification 438, and stored value 440 may be present. The general purpose and special-purpose functions 424 are given by way of example and not limitation, as other functions are easily imagined by those of ordinary skill.

The presentation of devices to the secured hardware interface 442, such as a device interface 444 and the BIOS interface 446, as well as the presentation of functions such as a reliable clock and random number generator may be made through virtual connection 448. Communication between the GPU core 410 in the secured core processor 416 may be made via a communication bus 450. In one embodiment, the communication bus 450 may transmit data over a secure channel to extend the trusted relationship from the secure core processor 416 to the GPU 410.

Described above are several specific embodiments including hardware and software embodiments for delicate metering of computer usage. A more fair and accurate method of determining and measuring beneficial usage is disclosed by monitoring and evaluating activity levels of one or more components of the computer 110 and applying appropriate business rules. This benefits a broad range of home, office and enterprise pay-per-use or metered-use applications. However, one of ordinary skill in the art will appreciate that various modifications and changes can be made to these embodiments, including but not limited to the use of different combinations of hardware or software for activity monitoring, multiple rate schedules, as well as more or less complex rules associated with determining an appropriate usage schedule. Accordingly, the specification and drawings are to be regarded in an illustrative rather than restrictive sense, and all such modifications are intended to be included within the scope of the present patent.

Although the present invention has been described with reference to preferred embodiments, workers skilled in the art will recognize that changes may be made in form and detail without departing from the spirit and scope of the invention.

What is claimed is:

1. A processing unit for use in an electronic device comprising:
a clock circuit providing a monotonically increasing time base; and
a tamper-resistant memory storing data corresponding to a usage policy that regulates operation of the electronic device in compliance with the usage policy.
